(19) United States
(12) Patent Application Publication
(10) Pub. No.: US 2007/0109803 A1
(43) Pub. Date: May 17, 2007

(54) MULTI-PURPOSE ILLUMINATION SET

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,148

(22) Filed: Nov. 11, 2005

(51) Int. Cl. B62J 6/00

(52) U.S. Cl. 362/473

(57) ABSTRACT

An illumination set includes a lighting device, a spare power pack, a cable and two mounting devices. The lighting device includes a light source and at least one battery for energizing the light source. The spare power pack includes at least one battery for energizing the light source. The cable electrically connects the spare power pack to the lighting device. Two mounting devices mount the spare power pack and the lighting device to a bicycle.

### BACKGROUND OF INVENTION

1. Field of Invention

The present invention relates to a multi-purpose illumination set and, more particularly, to an illumination set that can be used as a flashlight (or “electric torch”) and a headlight of a bicycle.

2. Related Prior Art

Taiwanese Patent M263287 discloses a lighting device 1 that can be used as flashlight (FIGS. 1 through 3) and a headlight of a bicycle (FIGS. 4 and 5). The lighting device 1 includes a main cylinder 10 for containing at least one battery, a secondary cylinder 11 connected to the main cylinder 10, a movable cylinder 12 inserted in the main cylinder 10, another movable cylinder 12 inserted in the secondary cylinder 10, a light 30 pivotally connected to the main cylinder 10 and a sleeve 13 movably put on the main cylinder 10. The secondary cylinder 11 is used to keep the battery in the main cylinder 10 and increase the entire length of the lighting device 1. A warning light 20 and a turn signal 21 are installed on each of the movable cylinders 12. When the light 30 is put axially on the main cylinder 10, the lighting device 1 is for use as a flashlight. When the light 30 is put transversely on the main cylinder 10, the lighting device 1 is for use as a headlight of the bicycle. The sleeve 13 can be moved between a first position for keeping the light 30 axially on the main cylinder 10 and a second position for allowing the pivotal of the light 30 on the main cylinder 10. A problem with the lighting device 1 is its small capacity of power. This problem is grave since the warning lights 20, the turn signals 21 and the light 30 together require a large power. The lighting device 1 will soon run out of power.

Therefore, the present invention is intended to obviate or at least alleviate the problems encountered in prior art.

### SUMMARY OF INVENTION

According to the present invention, an illumination set includes a lighting device, a spare power pack, a cable and two mounting devices. The lighting device includes a light source and at least one battery for energizing the light source. The spare power pack includes at least one battery for energizing the light source. The cable electrically connects the spare power pack to the lighting device. The mounting devices mount the spare power pack and the lighting device to a bicycle.

The primary advantage of the illumination set of the present invention is its large capacity of power.

Other advantages and novel features of the present invention will become apparent from the detailed description referring to the drawings.

### BRIEF DESCRIPTION OF DRAWINGS

The present invention will be described via detailed illustration of the preferred embodiment referring to the drawings.

FIG. 1 is a perspective view of an illumination set according to the preferred embodiment of the present invention.

FIG. 2 is a perspective view of the illumination set in another position than shown in FIG. 1.

FIG. 3 is an exploded view of the illumination set shown in FIG. 2.

FIG. 4 is a cross-sectional view of the illumination set taken along a line A-A in FIG. 1.

FIG. 5 is a perspective view of a bicycle equipped with the illumination set shown in FIG. 1.

FIG. 6 is an enlarged partial view of the bicycle equipped with the illumination set shown in FIG. 5.

FIG. 7 is a side view of a hand holding a lighting device of the illumination set shown in FIG. 1 for use as a flashlight.

### DETAILED DESCRIPTION OF PREFERRED EMBODIMENT

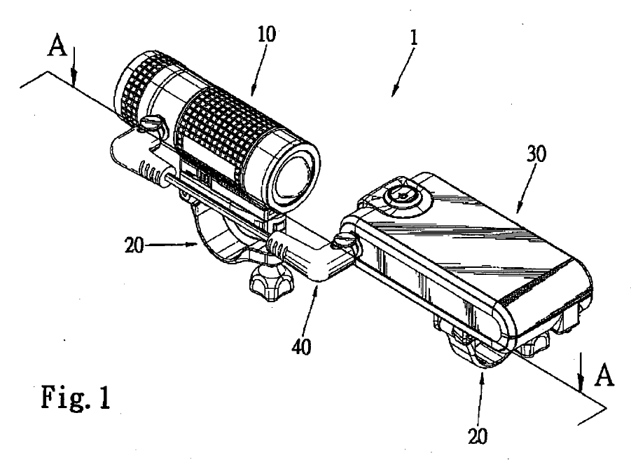

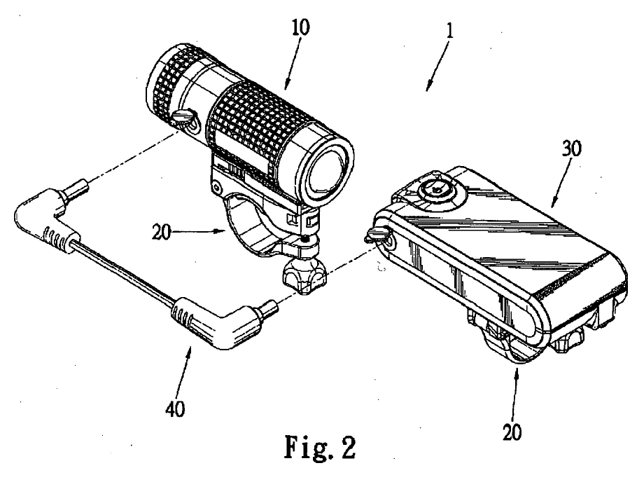

Referring to FIGS. 1 and 2, there is shown an illumination set 1 according to the preferred embodiment of the present invention. The illumination set 1 includes a lighting device 10, a spare power pack 30 and a cable 40 for electrically connecting the spare power pack 30 to the lighting device 10.

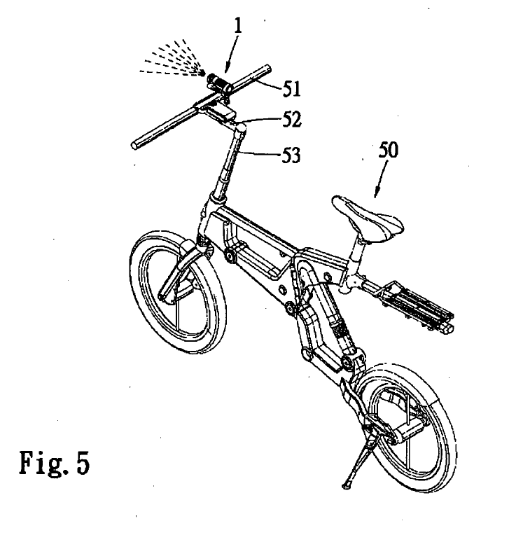

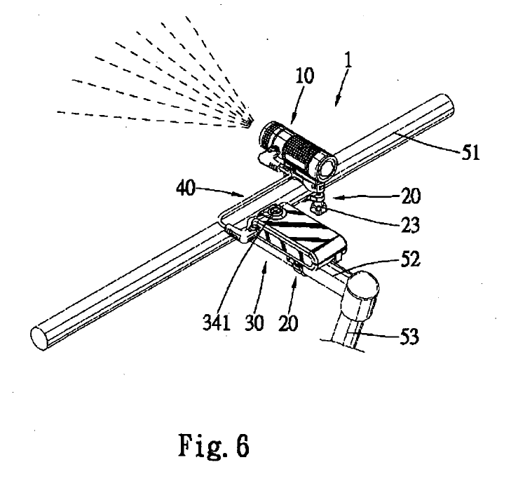

The illumination set 1 further includes two mounting devices 20, one for mounting the lighting device 10 on a handle bar 51 of a bicycle 50 (FIGS. 5 and 6) and the other for mounting the spare power pack 30 on a horizontal tube 52 extending between the handle bar 51 and the stem 53 of the bicycle 50.

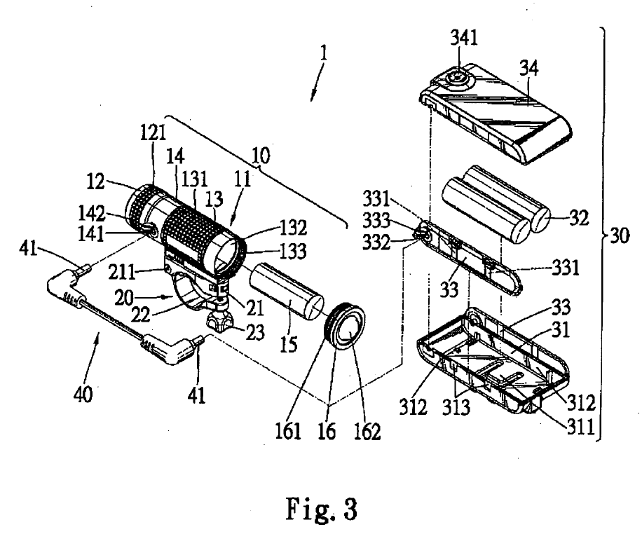

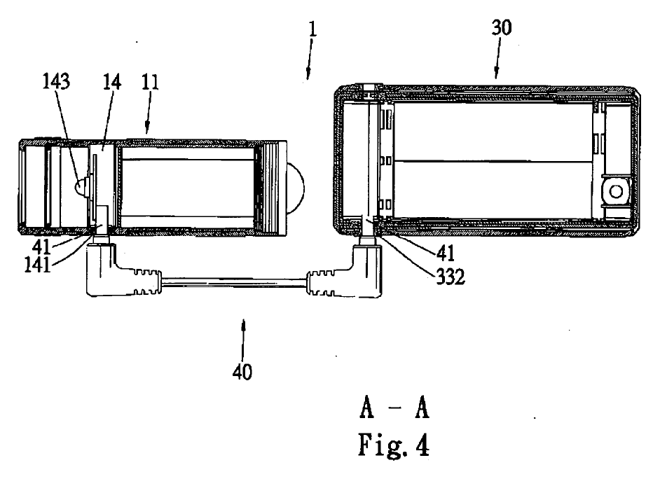

Referring to FIGS. 3 and 4, the lighting device 10 includes a lamp 143, a battery 15 for energizing the lamp 143 and a cylinder 11 defining a space 132 for containing the lamp 143 and the battery 15. The lamp 143 may be replaced with a light-emitting diode.

The cylinder 11 includes a first end 12, a second end 13 and a middle section 14. A texture 121 is formed on or made in the exterior of the cylinder 11 near the first end 12. A texture 131 is formed on or made in the exterior of the cylinder 11 near the second end 13. The textures 121 and 131 facilitate the gripping of the cylinder 11.

The cylinder 11 is provided with a socket 141 for receiving a plug 41 formed at an end of the cable 40. Pivotally connected to the cylinder 11 is a cover 142 for covering the socket 141 in order to keep miscellaneous objects away.

The cylinder 11 further includes a thread 133 formed on the interior near the second end 13. A cap 16 is formed with a thread 161 for engagement with thread 133 of the cylinder 11 so that the cap 16 retains the battery 15 in the cylinder 11. A switch 162 is provided on the cap 16. By operating the switch 162, a user can turn on and off the lamp 143.

The spare power pack 30 includes two batteries 32 and a case for containing the batteries 32. The case consists of a lower shell 31, an upper shell 34 for engagement with the lower shell 31 and two lateral covers 33 for connecting the upper shell 34 to the lower shell 31. The lower shell 31 defines a space 311 for receiving the batteries 32. The lower shell 31 includes two walls 312 each defining two recesses 313. The upper shell 34 is provided with a switch 341. At least one of the lateral shells 33 is provided with a socket 332 for receiving a plug 41 formed at another end of the cable 40 and a cover 333 connected thereto for closing the socket 332, thus keeping miscellaneous objects away. Each of the lateral shells 33 is formed with a locking block 331 for fitting in one of the recesses 313 of one of the walls 312.

Each of the mounting devices 20 includes a saddle 21 and a brace 22 pivotally connected to the saddle 21 by means of a pin or screw 211. The saddle 21 includes a top for contact with the cylinder 11 and a bottom for contact with the handle bar 51. Although not shown, a dovetail and a corresponding groove may be arranged between the cylinder 11 or the lower shell 31 and the top of the saddle 21. The top of the saddle 21 is concave in compliance with the handle bar 51. A fastener 23 can be driven in the brace 22 and the saddle 21 so that the mounting device 20 firmly clamps the handle bar 51 or the horizontal tube 52.

Referring to FIGS. 5 and 6, the illumination set 1 is used as a headlight of the bicycle 50. In this use, the lamp 143 of the lighting device 10 is energized by means of the batteries 32 of the spare power pack 30. The case can be made with a desired size in order to contain a desired number of batteries 32. As carried on the bicycle 50, the size of the spare power pack 30 is not a problem for the user.

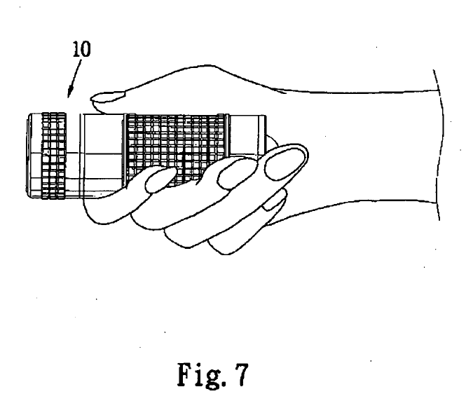

Referring to FIG. 7, the lighting device 10 is disconnected from the spare power pack 30 and used as a flashlight. In this use, the lamp 143 of the lighting device 10 is energized by means of the battery 15 of the lighting device 10. The lighting device 10 alone is small in size and light in weight and is therefore mobile.

Generally, the user rides faster than walks. Hence, the illumination set 1 would better provide a larger range of illumination used as the headlight of the bicycle 50 than used as the flashlight. This is why the lamp 143 is energized by means of the batteries 32 when the illumination set 1 is used as the headlight of the bicycle 50 and is energized by means of the battery 15 when the illumination set 1 is used as the flashlight.

The batteries 15 and 32 may be rechargeable batteries.

The illumination set 1 provides several advantages.

Firstly, it provides a large range of illumination when used as the headlight of the bicycle 50. Hence, the user can see far and clearly while riding. The user's safety is served.

Secondly, it provides mobility when used as the flashlight. Hence, the user can easily carry it. The user's convenience is served.

Thirdly, it can be on duty for a long period of time for including a large amount of batteries.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An illumination set comprising:
a lighting device comprising a light source and at least one battery for energizing the light source;
a spare power pack comprising at least one battery for energizing the light source; and
a cable for electrically connecting the spare power pack to the lighting device; and
two mounting devices for mounting the spare power pack and the lighting device to a bicycle.

2. The illumination set according to claim 1 wherein the lighting device comprises a cylinder for containing the battery.

3. The illumination set according to claim 2 wherein the cylinder comprises at least one texture for facilitating the grip thereof.

4. The illumination set according to claim 3 wherein the cylinder comprises a texture near an end and a texture near an opposite end.

5. The illumination set according to claim 1 wherein the battery of the lighting device is a rechargeable battery.

6. The illumination set according to claim 1 wherein the battery of the spare power pack is a rechargeable battery.

7. The illumination set according to claim 1 wherein the spare power pack comprises a plurality of batteries.

8. The illumination set according to claim 2 wherein the lighting device comprises a cap for connection to the cylinder.

9. The illumination set according to claim 8 wherein the lighting device comprises a switch installed on the cap.

10. The illumination set according to claim 1 wherein the spare power pack includes a case for containing the battery.

11. The illumination set according to claim 10 wherein the spare power pack comprises a switch installed on the case.

12. The illumination set according to claim 1 wherein the lighting device comprises a cylinder for containing the battery and a socket installed on the cylinder, wherein the spare power pack includes a case for containing the battery and a socket installed on the case, wherein the cable comprises two plugs for insertion in the sockets.

13. The illumination set according to claim 12 wherein the lighting device comprises a cover for closing its socket.

14. The illumination set according to claim 13 wherein the cover is connected to the cylinder.

15. The illumination set according to claim 12 wherein the spare power pack comprises a cover for closing its socket.

16. The illumination set according to claim 15 wherein the cover is connected to the case.

17. The illumination set according to claim 1 wherein each of the mounting devices comprises:
a saddle for supporting one of the lighting device and the spare power pack; and
a brace pivotally connected to the saddle in order to clamp a portion of the bicycle.

18. The illumination set according to claim 17 wherein the bottom of the saddle is concave in compliance with the profile of the portion of the bicycle.

19. The illumination set according to claim 17 wherein each of mounting device comprises a fastener that can be driven in the brace and the saddle.
